(19) United States
(12) Patent Application Publication
(10) Pub. No.: US 2026/0274087 A1
(43) Pub. Date: Sep. 17, 2026

(54) SCALABLE BATTERY AND SUPPORT SYSTEM FOR MARINE APPLICATIONS

(71) Applicant: Polaris Industries Inc., Medina, MN (US)

(72) Inventors: Erik Rogers, Briston, IN (US); Michael Yobe, Knoxville, TN (US)

(21) Appl. No.: 19/167,051

(22) PCT Filed: Mar. 26, 2024
(86) PCT No.: PCT/US2024/021455

§ 371 Date: Sep. 19, 2025

Related U.S. Application Data
(60) Provisional application No. 63/455,186, filed on Mar. 28, 2023.

(51) Int. Cl. B60L 50/64; B60L 58/10; B63B 3/34; B63B 3/48; B63B 35/38; H01M 10/42; H01M 50/204; H01M 50/249; H01M 50/256; H01M 50/262

(52) U.S. Cl. CPC B60L 50/64; B60L 58/10; B63B 3/34; B63B 3/48; B63B 35/38; H01M 10/425; H01M 50/204; H01M 50/249; H01M 50/256; H01M 50/262; B60L 2200/32; B60L 2250/16; H01M 2010/4271; H01M 2220/20

(57) ABSTRACT

An energy system for a watercraft comprises a plurality of battery packs and a cart. The cart may include a power receptacle, a wheel assembly, a handle assembly, and a plurality of transport compartments. Each transport compartment may be configured to receive a battery pack and may include at least one connector configured to mate with a receptacle assembly of the battery pack. The cart may be configured to transfer power from the power receptacle to the plurality of battery packs to charge the plurality of battery packs and to transport the battery packs to and from a watercraft via the wheel assembly and the handle assembly. Each battery pack may be configured to be received through at least one opening in a rub rail of the watercraft into at least one battery compartment formed between C-channels of the frame of the watercraft to provide power to the watercraft.

### CROSS-REFERENCE TO RELATED APPLICATION

The present application claims the benefit of U.S. Provisional Application No. 63/455,186, entitled “SCALABLE BATTERY AND SUPPORT SYSTEM FOR MARINE APPLICATIONS,” filed on Mar. 28, 2023, which is incorporated by reference herein for all purposes in its entirety.

### TECHNICAL FIELD

The present application relates generally to watercraft, and more specifically to scalable, modular energy systems for watercraft such as pontoon boats.

### BACKGROUND

Electrification of propulsion systems for watercraft is becoming more prevalent. However, the energy storage devices (i.e., batteries) for use in such systems are heavy and difficult to transport to and locate on the watercraft. There is a need for a scalable battery system that provides easy transportation of multiple batteries, scalable configuration of batteries according to the desired activity, and desirable placement of the batteries within available space on the watercraft.

### SUMMARY

According to one embodiment of the disclosure, a watercraft is provided, comprising: a frame including a plurality of C-channels extending substantially perpendicularly relative to a longitudinal axis of the watercraft, and a rub rail extending along at least one side of the watercraft, the rub rail including a plurality of access doors; and a deck mounted to the frame; wherein the deck and adjacent C-channels of the plurality of C-channels define a plurality of compartments below the deck, each of the plurality of compartments including an opening being accessible by moving a corresponding one of the plurality of access doors; and wherein each compartment includes at least one connector and a retention mechanism, the connector being configured to electrically connect to a battery pack received into the compartment via the opening, and the retention mechanism being configured to engage the battery pack to secure it in place. In one aspect of this embodiment, each compartment further comprises a conveyor mechanism that permits more than one battery pack to be inserted into the compartment. In another aspect, the frame further comprises a pair of outer tubes and a center tube disposed between the outer tubes, the C-channels connecting the outer tubes and the center tube. In a variant of this aspect each of the plurality of C-channels includes an upper surface, a distance between the upper surface and an upper surface of the pair of outer tubes and the upper surface of the C-channel being approximately 3.5 inches. In another aspect, a distance between adjacent C-channels is approximately 16 inches. In a further aspect, the watercraft is a pontoon boat.

In another embodiment, an energy system for a watercraft is provided, comprising: a plurality of battery packs; and a cart including a power receptacle, a wheel assembly, a handle assembly, and a plurality of transport compartments, each transport compartment being configured to receive one of the plurality of battery packs and including at least one connector configured to mate with a receptacle assembly of the battery pack; wherein the cart is configured to transfer power from the power receptacle to the plurality of battery packs to charge the plurality of battery packs, and to transport the battery packs to and from a watercraft via the wheel assembly and the handle assembly; and wherein each of the plurality of battery packs is configured to be received through an opening in a rub rail of the watercraft into a battery compartment formed between C-channels of the frame of the watercraft to provide power to the watercraft. In one aspect of this embodiment, the receptacle assembly of each of the plurality of battery packs includes an outer wall that defines an inner volume, and at least one connector disposed within the inner volume and configured to mate with the at least one connector of the plurality of transport compartments. In a variant of this aspect, the outer wall includes a retention feature configured to mate with a retention mechanism of a transport compartment. Another aspect of this embodiment further comprises a battery management system mounted to the watercraft and configured to control operation of the plurality of battery packs. In a variant of this aspect, the battery management system is programmable by a user to adjust the operation of the plurality of battery packs to correspond to a user-selected trip description. In another variant, the battery management system is configured to receive information from a propulsion system describing requirements of the propulsion system, and to control energy delivery from the plurality of battery packs to the requirements of the propulsion system. In another aspect, each of the plurality of battery packs includes a handle assembly having a pair of arms and a handle extending between the pair of arms. In a further aspect, the cart further includes an upper console including a shelf and a display. In a variant of this aspect, the handle assembly includes a pair of arms extending upwardly and rearwardly of the upper console, and a handle portion extending between distal ends of the pair of arms. In yet another aspect of this embodiment, the cart further includes a pair of legs extending downwardly from a lower surface of a body of the cart, each of the pair of legs being disposed adjacent a front corner of the body. In a further aspect, the wheel assembly includes a pair of wheels connected together by an axle that extends through openings adjacent rear corners of a body of the cart. In still another aspect of this embodiment, the watercraft is a pontoon boat.

### BRIEF DESCRIPTION OF THE DRAWINGS

The above mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a perspective view of a conventional watercraft;

FIG. 2 is an end view of a portion of the watercraft of FIG. 1;

FIG. 3 is a perspective view of components of the watercraft of FIG. 1;

FIG. 4 is a perspective view of portions of an embodiment of a watercraft according to the present disclosure;

FIG. 5 includes an end view and a bottom perspective view of the watercraft of FIG. 4;

FIG. 6 is a perspective view of a portion of another embodiment of a watercraft according to the present disclosure;

FIG. 7 is a perspective view of another embodiment of a watercraft and an energy system according to the present disclosure;

FIG. 8 is a perspective view of a frame of the watercraft of FIG. 7;

FIG. 9 includes various views of a battery pack of the energy system of FIG. 7;

FIG. 10 is a perspective view of a storage/charging cart of the energy system of FIG. 7;

FIG. 11 is a perspective view of a portion of the watercraft of FIG. 7; and

FIG. 12 is a side view of a watercraft according to the present disclosure.

Corresponding reference characters may indicate corresponding parts throughout the several views.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated.

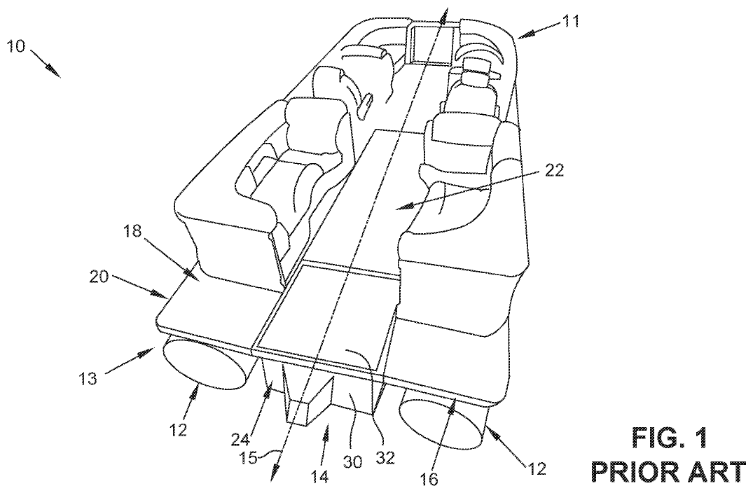

Referring now to FIG. 1, a watercraft 10 is shown as generally having a pair of outer pontoon tubes 12, a center pontoon tube 14, a frame 16, a deck 18 disposed on the frame 16, a rub rail 20 between the deck 18 and the frame 16, a floor hatch 22, and a propulsion assembly 24. The watercraft 10 generally includes a bow 11, a stern 13 and a longitudinal axis 15. It should be understood that while the principles of the present disclosure are described in an exemplary embodiment of a pontoon boat, the teachings of the present disclosure are applicable to a variety of other watercraft and vehicles.

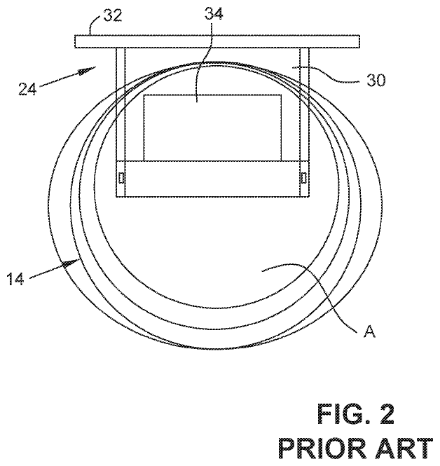

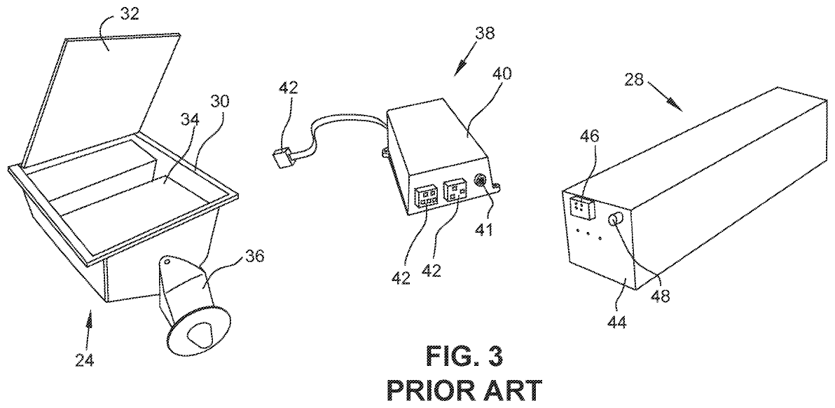

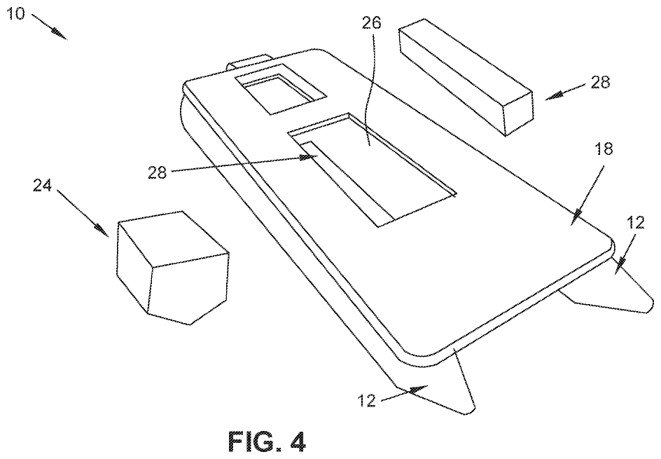

The floor hatch 22 may be opened to expose a battery storage compartment 26 (FIG. 4) which houses one or more batteries 28 as is further described below. As best shown in FIG. 3, the propulsion assembly 24 includes a housing 30 and a cover 32 which is attached by at least one hinge mechanism (not shown) to permit opening and closing of the cover 32. The housing 30 houses an electric motor 34 which is coupled to a propeller assembly 36. As shown in FIG. 2, the battery storage compartment 26 and the propulsion assembly 24 are sized to fit within a cross-sectional area A of any of a variety of different sized center tubes 14.

As best shown in FIG. 3, the various types of batteries described herein are controlled by a battery management system (hereinafter, “BMS 38”). The BMS 38 includes a housing 40 configured to be mounted to the watercraft 10, an indicator 41, and a plurality of connectors 42 for receiving power, providing control signals to the batteries, and receiving signals from sensors (not shown) associated with the batteries indicating battery temperature, state-of-charge, etc. In one embodiment, the housing 40 of the BMS 38 is approximately 20 inches long, 8 inches high and 12 inches wide.

Still referring to FIG. 3, battery 28 is shown as having an enclosure 44 with at least one connector 46 and an indicator 48. Enclosure 44 is formed as a generally elongated cube which, in one embodiment is approximately 48 inches long, 18 inches high and 18 inches wide. The at least one connector 46 permits the battery 28 to receive control signals from the BMS 38, provide sensor and status signals to the BMS 38, and provide output power to the propulsion assembly 24 and other electronics on board the watercraft 10 (e.g., lights, audio system, horn, various control systems, etc.). The indicator 48 may indicate that the battery 28 is activated by glowing steady, or provide other status information (e.g., state-of-charge, over-temperature, etc.) by flashing, glowing different colors, etc. In one embodiment, the battery 28 is a 90 KwH cell which may provide sufficient power in certain applications to provide the watercraft 10 with a range of approximately 70 miles at a cruising speed of approximately 20 mph. In such an embodiment, the battery 28 weighs approximately 300 pounds, which is approximately equal to the weight of five conventional series 29 lead acid batteries.

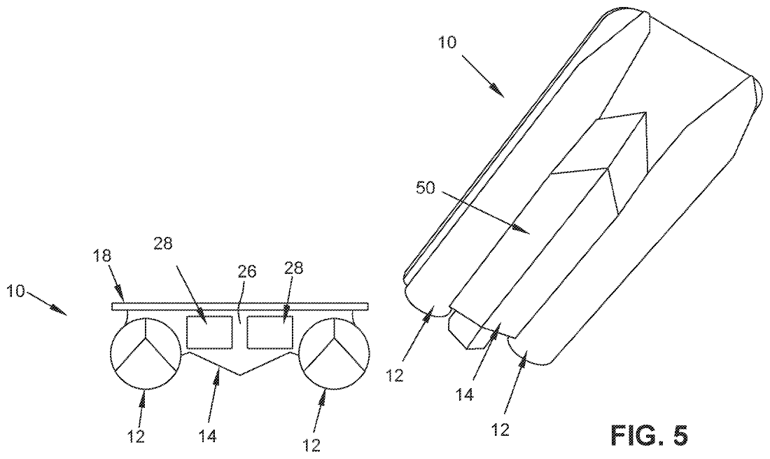

Referring now to FIG. 4, a simplified illustration of the watercraft 10 is shown with a propulsion assembly 24 and two batteries 28 according to one embodiment of the disclosure. In this embodiment, the battery storage compartment 26 is sized to receive the two batteries 28 (one shown installed, and one shown removed). As shown in FIG. 5, the battery storage compartment 26 permits the batteries 28 to be housed in a side-by-side configuration substantially within the center tube 14. This embodiment of the watercraft 10 includes a revised running surface 50 to accommodate the two batteries 28 and thereby extend the operating range of the watercraft 10.

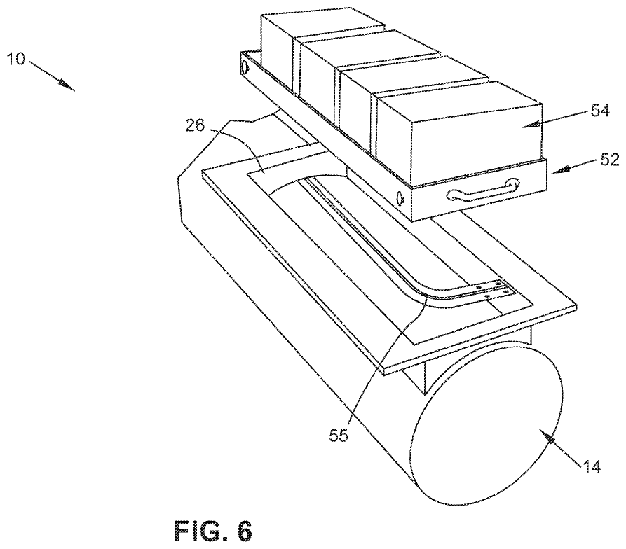

As shown in FIG. 6, in a different embodiment, the battery storage compartment 26 is configured to receive a tray 52 that carries a plurality of smaller batteries 54. The battery storage compartment 26 includes at least one rail 55 that permits movement of the tray 52 toward and away from the stern 13 of the watercraft 10, thereby shifting the weight of the batteries 54 along the longitudinal axis 15 of the watercraft 10 and accommodating watercraft of different lengths. This permits the location of the batteries 54 to effect the center of gravity of the watercraft 10 to inhibit porpoising, a sustained, repetitive motion that causes the bow 11 of the watercraft 10 to bounce up and down out of the water, even in relatively calm waters. It should be understood that the tray 52 is configured to receive one or more of the plurality of batteries 54 depending upon the expected activity for the watercraft 10 (i.e., a short cruise, a longer cruise, tubing, etc.).

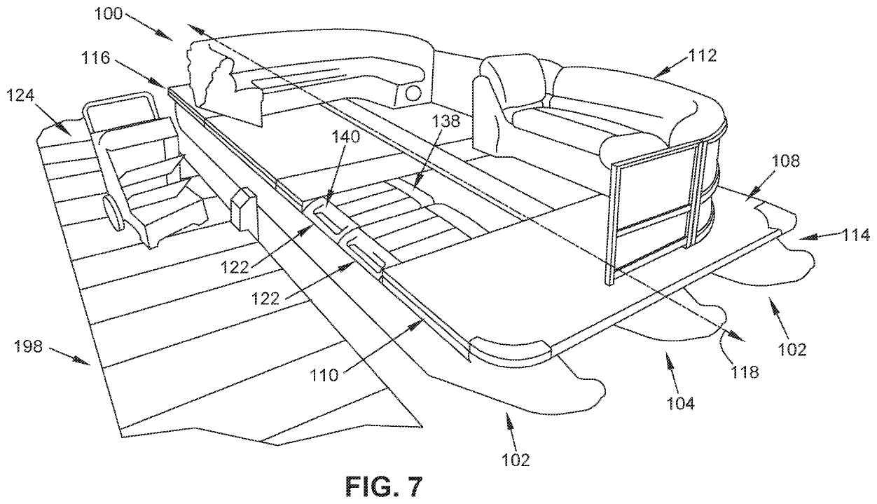

Referring now to FIG. 7, one embodiment of the present disclosure is shown. In this embodiment, the watercraft 100 is shown as generally having a pair of outer pontoon tubes 102, a center pontoon tube 104, a frame 106, a deck 108 disposed on the frame 106, a rub rail 110 between the deck 108 and the frame 106, furniture 112, a bow 114, a stern 116 and a longitudinal axis 118. In this embodiment, the watercraft 100 is configured to utilize an energy system 120 according to the present disclosure. The energy system 120 generally includes a plurality of battery packs 122, a BMS 38, and a storage/charging cart 124. The battery packs 122, the BMS 38 and the associated wiring (not shown) are disposed within an otherwise unused portion of the watercraft 100 as is further described below.

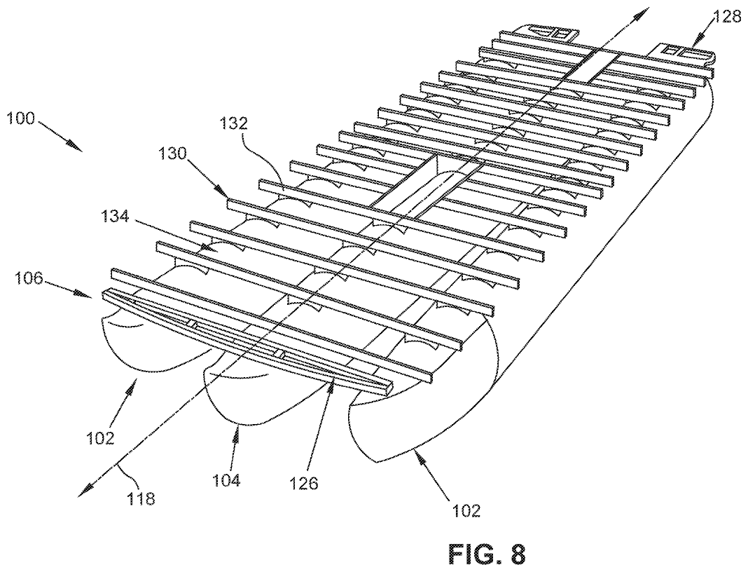

Referring to FIG. 8, the watercraft 100 is shown with the deck 108 and rub rail 110 removed (as well as all components above the deck 108). This view illustrates the frame 106, which includes a bow bumper 126, a stern bumper 128 and a plurality of C-channels 130 arranged as deck joists. The C-channels 130 along with the bow bumper 126 and the stern bumper 128 interconnect the outer tubes 102 and the center tube 104 to form the frame 106 or chassis of the watercraft 100. In one embodiment, the C-channels are substantially equally spaced apart by approximately 16 inches from one another and extend substantially parallel to the longitudinal axis 118 of the watercraft 100. The deck 108 is attached to the upper surfaces 132 of the C-channels 130. In one embodiment, the distance between the upper surfaces of the tubes 102, 104 and the lower surface of the deck 108 (i.e., the height of the C-channels 130) is approximately 3.5 inches. This provides a compartment 134 of width W and height H between each pair of adjacent C-channels 130. The compartment 134 between adjacent C-channels 130 in many instances along the longitudinal axis 118 of the watercraft 100 extends substantially across the entire width of the frame 106 (i.e., from the port side to the starboard side of the watercraft 100). As is further described below, these compartments 134 may be utilized to removably house the battery packs 122, the BMS 38 and the associated wiring of the energy system 120.

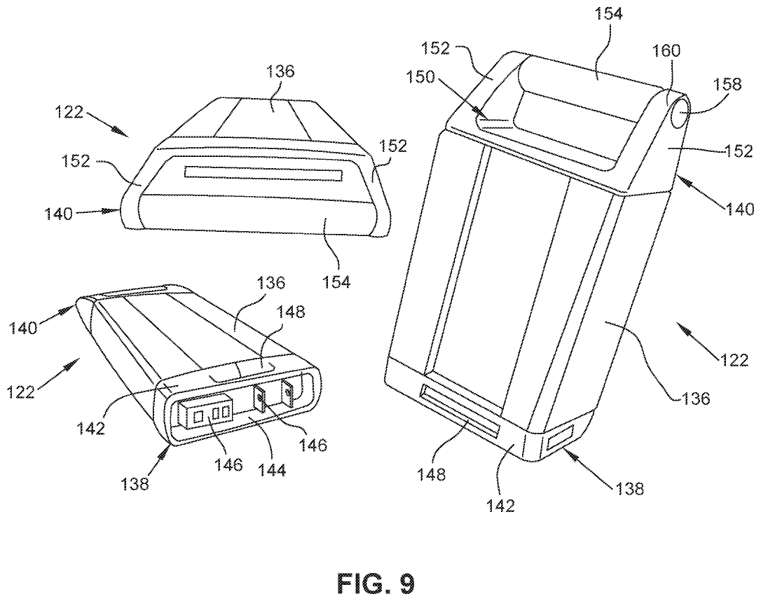

Referring now to FIG. 9, the battery packs 122 of the energy system 120 are shown in greater detail. Each battery pack 122 includes a housing 136 that encloses the battery components and interconnecting structures, a receptacle assembly 138 at one end of the housing 136, and a handle assembly 140 at the other end of the housing 136. The receptacle assembly 138 includes an outer wall 142 that extends from the housing 136 and defines an inner volume 144. A plurality of connectors 146 extend from the housing 136 into the inner volume 144 and are protected by the outer wall 142. The plurality of connectors 146 are configured to mate with corresponding connectors to communicate with the BMS 38 and provide power to the electronics and propulsion assembly 24 of the watercraft 100. The outer wall 142 further includes a retention feature 148 configured to mate with and/or engage a retention mechanism (not shown) disposed within the frame 106 to hold the battery pack 122 in position when it is installed on the watercraft 100 as is further described below. In the embodiment shown, the retention feature 148 is formed as a groove or opening in the outer wall 142 of the receptacle assembly 138.

The handle assembly 140 includes a body 150 connected to the housing 136 of the battery pack 122, a pair of arms 152 extending from the body 150, and a handle 154 extending between the arms 152. In certain embodiments, the handle 154 includes an axle 156 with ends 158 that extend through openings 160 formed through the arms 152. In this manner, the handle 154 can rotate about the axle 156 while remaining supported between the arms 152.

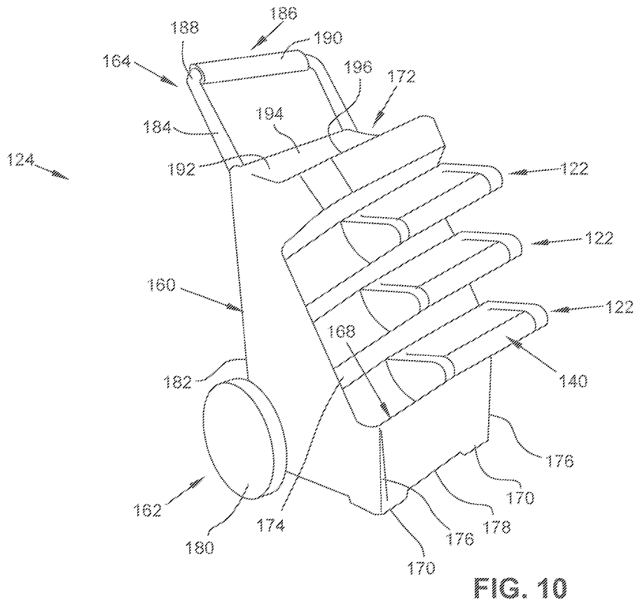

Referring now to FIG. 10, the cart 124 of the energy system 120 generally includes a body 160, a wheel assembly 162 and a handle assembly 164. The body 160 includes a plurality of transport compartments 168 (three shown), a pair of legs 170, and an upper console 172. Each of the plurality of transport compartments 168 is configured to receive a battery pack 122 and includes a plurality of connectors (not shown) configured to mate with the connectors 146 of the receptacle assembly 138 of a battery pack 122. The transport compartments 168 further include a lower support surface 174 to support and position the battery pack 122 when it is inserted into the transport compartment 168. As shown, the battery packs 122 are inserted into the transport compartments 168 receptacle assembly 138 first, leaving access to the handle assembly 140 for easy removal of the battery pack 122. The legs 170 of the cart body 160 are positioned adjacent the front corners 176 of the body 160 and extend downwardly from a lower surface 178 of the body 160. As should be apparent from the figures, the legs 170 extend downwardly from the lower surface 178 a distance substantially equal to the distance between the lower surface 178 and the contact points between the wheel assembly 162 and the ground, thereby maintaining the cart 124 is a substantially level orientation when the cart 124 is at rest.

The wheel assembly 162 of the cart 124 includes a pair of wheels 180 (one shown) connected together by an axle (not shown) that extends through openings (not shown) adjacent the rear corners 182 of the body 160. The handle assembly 164 includes a pair of arms 184 that extend upwardly and rearwardly of the upper console 172 of the body 160, and a handle portion 186 that extends between distal ends 188 of the arms 184. The handle portion 186 may include a grip 190 along at least a portion of its length. The cart 124 may be moved from location to location by grasping the handle portion 186 and tilting the cart 124 rearwardly on the wheels 180, and then rolling the cart on the wheels 180 by pulling or pushing the handle portion 186.

The upper console 172 of the body 160 incudes a shelf 192 formed on an upper surface 194 of the body 160 for holding items such as tools or keys. The upper console 172 further includes a display 196 positioned to be viewable by a user located near the handle assembly 164 of the cart 124. The display 196 may function as a user interface that provides information to the user and permits control of certain functions of the cart 124.

The cart 124 further includes a power cord (not shown) or a receptacle (not shown) for mating with a power cord to provide power to the cart 124 for powering the electronics of the cart 124 and charging the battery packs 122. The cart 124 includes internal electronics (not shown) for controlling charging of the battery packs 122 and operation of the display 196. When battery packs 122 are installed into the transport compartments 168 of the body 160 of the cart 124 and power is provided to the cart 124, the internal electronics provide power to the battery packs 122 to charge the packs for use. The cart 124 may be moved to a garage or other location having a power source for charging of the battery packs 122.

When the packs 122 are charged, the cart 124 and the battery packs 122 may be moved in the manner described herein to the location of the watercraft 100, such as near a dock 198 (FIG. 7). This functionality eliminates the need for a user to install a power outlet near the dock 198, which in some circumstances would cost thousands of dollars. It also eliminates the risk of connecting extension cords from a power outlet away from the dock 198 (e.g., at a home or garage) and running the extension cords over a lawn or other area to the dock 198. These risks include tripping over the extension cords, damaging the extension cords with a vehicle or lawn equipment, and electrical shock by locating extension cords on or near wet surfaces. More generally, the use of the energy system 120 as described herein, particularly with an all-electric watercraft 100, eliminates the hazards associated with transporting fuel to the watercraft 100 (e.g., spillage, fire, etc.). Even operators of conventional combustion engine powered watercraft 100 will benefit from the energy system 120 as such watercraft 100 still require at least one battery to power the on-board electronics of the watercraft 100. The cart 124 may be used to transport one or more fully charged battery packs 122 to the watercraft 100 to replace depleted battery packs 122, and to transport the depleted battery packs 122 back to a storage location where the cart 124 can be powered to charge the depleted battery packs 122.

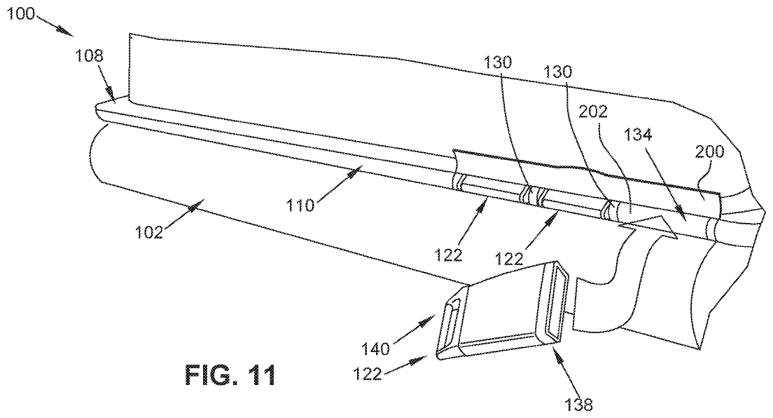

Referring now to FIGS. 7 and 11, a portion of the deck 108 is removed to show battery packs 122 installed between C-channels 130 of the frame 106. As shown in FIG. 7 and FIG. 11, the battery packs 122 are inserted receptacle assembly 138 first into the compartments 134 between the C-channels 130. In one embodiment, as a battery pack 122 is fully inserted into a compartment 134, a retention mechanism (not shown) within the compartment 134 engages the retention feature 148 of the outer wall 142 of the receptacle assembly 138 to secure the battery pack 122 in place. The retention mechanism may be one or more spring loaded latches that cam over the outer surface of the outer wall 142 and move under the biasing force of the spring into the retention feature 148 of the outer wall 142, thereby retaining the battery pack 122 in place. With sufficient force pulling the battery pack 122 outwardly from the compartment 134, the retention mechanism may disengage from the retention feature 148 to permit removal of the battery pack 122. It should be understood that as the battery pack 122 is retained in place by the retention mechanism, the connectors 146 of the receptacle assembly 138 mechanically and electrically connect with corresponding connectors (not shown) mounted within the compartment 134 to provide interconnectivity between the battery pack 122 and the internal wiring to the BMS 38 and other on-board electronics.

Alternatively, the retention mechanism may be located adjacent the openings 202 of the compartments 134 and actuatable by the user. For example, the retention mechanism may be a latch or other mechanism that engages the battery pack 122 to secure it in place and is movable by the user to a disengaged position to permit removal of the battery pack 122. In this and other embodiments, when the retention mechanism disengages from the battery pack 122, the power connection to the battery pack 122 is also disconnected or turned off.

In another embodiment, the compartment 134 between adjacent C-channels 130 may include a conveyor mechanism (not shown) that permits more than one battery pack 122 to be inserted into the compartment 134. More specifically, the conveyor mechanism could include rails or tracks with appropriate retention mechanisms and connectors that form multiple receiver locations that permit movement of battery packs 122 toward the starboard side of the watercraft 100. After one battery pack 122 is inserted into the compartment 134 in the manner described above, another battery pack 122 may be pushed into the compartment 134, thereby moving the first battery pack 122 on the conveyor mechanism toward the starboard side of the watercraft 100. As the first battery pack 122 moves toward the starboard side of the watercraft 100, another set of connectors and a retention mechanism located on the conveyor mechanism mate with the second battery pack 122. In this manner, the weight of the battery packs 122 may be more evenly distributed between the port side and the starboard side of the watercraft 100 to provide improved performance.

In still another embodiment, the mating connectors in the compartments 134 could include waterproof gaskets to protect the connections with the connectors 146 of the battery packs 122. Additionally, the mating connectors and the connectors 146 may be magnetized to maintain the connections, instead of or in addition to using the retention mechanisms described above.

Referring now to FIG. 11, the rub rail 110 of the watercraft 100 includes moveable segments or access doors 200 that pivot upwardly to expose openings 202 into the compartments 134. The battery packs 122 are inserted into the openings 202 in the manner described herein, and the access doors 200 are pivoted downward to close the openings 202 and form part of the rub rail 110.

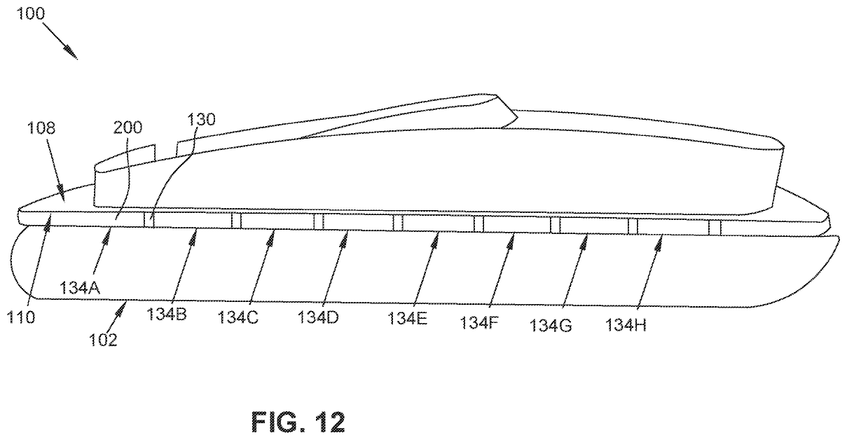

FIG. 12 shows a watercraft 100 with a rub rail 110 having multiple access doors 200 and corresponding openings 202 and compartments 134 for receiving battery packs 122. By providing multiple locations for inserting battery packs 122, the watercraft 204 may be configured for power output capacity that matches the intended use of the watercraft 204 on a particular outing. For example, four battery packs 122 may be installed into the first two compartments 134A, 134B for a short cruise outing or dinner trip of, for example, less than 25 miles at a cruising speed of approximately 20 mph. Alternatively, eight battery packs 122 may be installed into the first four compartments 134A-D for a moderate cruise or day trip of, for example, less than 70 miles at a cruising speed of approximately 20 mph. In still another example, 16 battery packs 122 may be installed into all eight depicted compartments 134A-H for an active cruise of, for example, less than 70 miles at a cruising speed of approximately 20 mph and two hours of high throttle operation for watersports. In this manner, the energy system 120 of the present disclosure may be configured to match the range and performance requirements for a variety of different uses of the watercraft 204.

As described above, various configurations may be provided to permit distribution of the weight of the battery packs 122 over the length and width of the watercraft 100. One benefit of use of battery packs 122 in this manner as compared to a conventional fuel powered watercraft with one or more internal combustion engines is the weight of the battery packs 122 and the distribution of that weight remains unchanged as the watercraft 100 is used. In a convention fuel powered watercraft, as the fuel is burned, the center of gravity of the watercraft changes, which affects the performance of the watercraft and may result in porpoising.

In another embodiment of the present disclosure, the BMS 38 is programmable by the user through a user interface (not shown). In this manner, the user may be presented with a variety of trip descriptions as options, and select a trip description that matches the intended use of the watercraft 100. The user interface may instruct the user to install a certain number of battery packs 122 that correspond to the power required for the selected trip description. During the trip as the energy in the battery packs 122 is depleted, the user interface may provide information to the user about the amount of power remaining to ensure that the watercraft 100 is able to reach the desired end point for the trip. Additionally, the BMS 38 may use the trip description to determine when to disable certain electrical loads (e.g., the audio system, the refrigerator, etc.) to ensure that sufficient power is available for the watercraft 100 to reach the desired end point.

Additionally, the BMS 38 may be configured to be propulsion system agnostic. In other words, the BMS 38 may be configured receive information from the propulsion system to determine its power requirements, etc., to control the energy delivery of the battery packs 122 to the specific requirements of the propulsion system. In this manner, any of a variety of different propulsion systems may be used with the watercraft 100 without requiring use of particular batteries or a redesign of the energy system 120.

The following items are further variations and examples of the embodiments described with reference to the figures.

### EXAMPLE 1

A watercraft may comprise a frame including a plurality of C-channels extending substantially perpendicularly relative to a longitudinal axis of the watercraft, and a rub rail extending along at least one side of the watercraft. The rub rail may include a plurality of access doors. The watercraft may further comprise a deck mounted to the frame. The deck and adjacent C-channels of the plurality of C-channels may define a plurality of compartments below the deck. Each of, or at least one of, the plurality of compartments may include an opening being accessible by moving a corresponding one of the plurality of access doors. Each compartment may include at least one connector and/or a retention mechanism. The connector may be configured to electrically connect to a battery pack received into the compartment via the opening. The retention mechanism may be configured to engage the battery pack to secure it in place.

### EXAMPLE 2

The watercraft of Example 1, wherein each compartment, or at least one of, may further comprise a conveyor mechanism that permits more than one battery pack to be inserted into the compartment.

### EXAMPLE 3

The watercraft of Example 1, wherein the frame may further comprise a pair of outer tubes and a center tube disposed between the outer tubes. The C-channels may connect the outer tubes and the center tube.

### EXAMPLE 4

The watercraft of Example 3, wherein each of, or at least one of, the plurality of C-channels may include an upper surface. A distance between the upper surface of the pair of outer tubes and the upper surface of the C-channel may be approximately 3.5 inches.

### EXAMPLE 5

The watercraft of Example 1, wherein a distance between adjacent C-channels may be approximately 16 inches.

### EXAMPLE 6

The watercraft of Example 1, wherein the watercraft may be a pontoon boat.

### EXAMPLE 7

An energy system for a watercraft may comprise a plurality of battery packs. The energy system may further comprise a cart which may include one or more of a power receptacle, a wheel assembly, a handle assembly, and a plurality of transport compartments. Each, or at least one, transport compartment may be configured to receive one of the plurality of battery packs and/or may include at least one connector. The at least one connector may be configured to mate with a receptacle assembly of the battery pack. The cart may be configured to transfer power from the power receptacle to the plurality of battery packs to charge the plurality of battery packs, and to transport the battery packs to and from a watercraft via the wheel assembly and the handle assembly. Each, or at least one, of the plurality of battery packs may be configured to be received through an opening in a rub rail of the watercraft into a battery compartment. The battery compartment may be formed between C-channels of the frame of the watercraft to provide power to the watercraft.

### EXAMPLE 8

The energy system of Example 7, wherein the receptacle assembly of each, or at least one, of the plurality of battery packs includes an outer wall that defines an inner volume. At least one connector may be disposed within the inner volume and may be configured to mate with the at least one connector of the plurality of transport compartments.

### EXAMPLE 9

The energy system of Example 8, wherein the outer wall may include a retention feature configured to mate with a retention mechanism of a transport compartment.

### EXAMPLE 10

The energy system of Example 7, may further comprise a battery management system mounted to the watercraft and configured to control operation of the plurality of battery packs.

### EXAMPLE 11

The energy system of Example 10, wherein the battery management system may be programmable by a user to adjust the operation of the plurality of battery packs to correspond to a user-selected trip description.

### EXAMPLE 12

The energy system of Example 10, wherein the battery management system may be configured to receive information from a propulsion system. The information may describe requirements of the propulsion system. The battery management system may control energy delivery from the plurality of battery packs to the requirements of the propulsion system.

### EXAMPLE 13

The energy system of Example 7, wherein each, or at least one, of the plurality of battery packs may include a handle assembly having a pair of arms and a handle portion extending between the pair of arms.

### EXAMPLE 14

The energy system of Example 7, wherein the cart may further include an upper console including a shelf and a display.

### EXAMPLE 15

The energy system of Example 14, wherein the handle assembly may include a pair of arms extending upwardly and rearwardly of the upper console, and a handle portion extending between distal ends of the pair of arms.

### EXAMPLE 16

The energy system of Example 7, wherein the cart may further include a pair of legs extending downwardly from a lower surface of a body of the cart. Each, or at least one, of the pair of legs being disposed adjacent a front corner of the body.

### EXAMPLE 17

The energy system of Example 7, wherein the wheel assembly may include a pair of wheels connected together by an axle that extends through openings adjacent rear corners of a body of the cart.

### EXAMPLE 18

The energy system of Example 7, wherein the watercraft may be a pontoon boat.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A watercraft, comprising:
a frame including a plurality of C-channels extending substantially perpendicularly relative to a longitudinal axis of the watercraft, and a rub rail extending along at least one side of the watercraft, the rub rail including a plurality of access doors; and
a deck mounted to the frame;
wherein the deck and adjacent C-channels of the plurality of C-channels define a plurality of compartments below the deck, each of the plurality of compartments including an opening being accessible by moving a corresponding one of the plurality of access doors; and
wherein each compartment includes at least one connector and a retention mechanism, the connector being configured to electrically connect to a battery pack received into the compartment via the opening, and the retention mechanism being configured to engage the battery pack to secure it in place.

2. The watercraft of claim 1, wherein each compartment further comprises a conveyor mechanism that permits more than one battery pack to be inserted into the compartment.

3. The watercraft of claim 1, wherein the frame further comprises a pair of outer tubes and a center tube disposed between the outer tubes, the C-channels connecting the outer tubes and the center tube.

4. The watercraft of claim 3, wherein each of the plurality of C-channels includes an upper surface, a distance between an upper surface of the pair of outer tubes and the upper surface of the C-channel being approximately 3.5 inches.

5. The watercraft of claim 1, wherein a distance between adjacent C-channels is approximately 16 inches.

6. The watercraft of claim 1, wherein the watercraft is a pontoon boat.

7. An energy system for a watercraft, comprising:
a plurality of battery packs; and
a cart including a power receptacle, a wheel assembly, a handle assembly, and a plurality of transport compartments, each transport compartment being configured to receive one of the plurality of battery packs and including at least one connector configured to mate with a receptacle assembly of the battery pack;
wherein the cart is configured to transfer power from the power receptacle to the plurality of battery packs to charge the plurality of battery packs, and to transport the battery packs to and from a watercraft via the wheel assembly and the handle assembly; and
wherein each of the plurality of battery packs is configured to be received through an opening in a rub rail of the watercraft into a battery compartment formed between C-channels of the frame of the watercraft to provide power to the watercraft.

8. The energy system of claim 7, wherein the receptacle assembly of each of the plurality of battery packs includes an outer wall that defines an inner volume, and at least one connector disposed within the inner volume and configured to mate with the at least one connector of the plurality of transport compartments.

9. The energy system of claim 8, wherein the outer wall includes a retention feature configured to mate with a retention mechanism of a transport compartment.

10. The energy system of claim 7, further comprising a battery management system mounted to the watercraft and configured to control operation of the plurality of battery packs.

11. The energy system of claim 10, wherein the battery management system is programmable by a user to adjust the operation of the plurality of battery packs to correspond to a user-selected trip description.

12. The energy system of claim 10, wherein the battery management system is configured to receive information from a propulsion system describing requirements of the propulsion system, and to control energy delivery from the plurality of battery packs to the requirements of the propulsion system.

13. The energy system of claim 7, wherein each of the plurality of battery packs includes a handle assembly having a pair of arms and a handle portion extending between the pair of arms.

14. The energy system of claim 7, wherein the cart further includes an upper console including a shelf and a display.

15. The energy system of claim 14, wherein the handle assembly includes a pair of arms extending upwardly and rearwardly of the upper console, and a handle portion extending between distal ends of the pair of arms.

16. The energy system of claim 7, wherein the cart further includes a pair of legs extending downwardly from a lower surface of a body of the cart, each of the pair of legs being disposed adjacent a front corner of the body.

17. The energy system of claim 7, wherein the wheel assembly includes a pair of wheels connected together by an axle that extends through openings adjacent rear corners of a body of the cart.

18. The energy system of claim 7, wherein the watercraft is a pontoon boat.
